(19) United States
(12) Patent Application Publication
(10) Pub. No.: US 2017/0363209 A1
(43) Pub. Date: Dec. 21, 2017

(54) ROTARY MACHINE SYSTEM

(71) Applicants: MITSUBISHI HEAVY INDUSTRIES, LTD., Tokyo (JP); MITSUBISHI HEAVY INDUSTRIES COMPRESSOR CORPORATION, Tokyo (JP)

(72) Inventors: Ryo Egami, Tokyo (JP); Takeshi Kaneko, Tokyo (JP); Kazutoshi Yokoo, Tokyo (JP); Masaki Shakuda, Hiroshima-shi (JP); Masahiro Hayashi, Hiroshima-shi (JP); Tomoaki Takeda, Hiroshima-shi (JP)

(73) Assignees: MITSUBISHI HEAVY INDUSTRIES, LTD., Tokyo (JP); MITSUBISHI HEAVY INDUSTRIES COMPRESSOR CORPORATION, Tokyo (JP)

(21) Appl. No.: 15/545,217

(22) PCT Filed: Oct. 15, 2015
(86) PCT No.: PCT/JP2015/079236

§ 371 Date: Jul. 20, 2017

(30) Foreign Application Priority Data
Jan. 23, 2015 (JP) 2015-011241

(51) Int. Cl. F16J 15/34; F04D 29/10; F04D 27/00

(52) U.S. Cl. CPC F16J 15/3452; F04D 27/001; F04D 29/104

(57) ABSTRACT

A rotary machine system includes: a rotary machine including a gas seal portion; a gas seal device connected to the rotary machine and that supplies a seal gas to the gas seal portion; a pressure sensor that detects a pressure of the seal gas; a vent portion that discharges the seal gas discharged from the gas seal portion; and a vent pressure sensor that detects a pressure in the vent portion. The rotary machine includes: a casing through which a working fluid flows; a rotatable rotary shaft that passes; and the gas seal portion provided between the casing and the rotary shaft and that seals the working fluid by the seal gas having a pressure higher than a pressure of the working fluid in the casing. The gas seal device includes: a pressure regulating valve; and a control part that controls the pressure regulating valve.

### TECHNICAL FIELD

The present invention relates to a rotary machine system. Priority is claimed on Japanese Patent Application No. 2015-11241, filed Jan. 23, 2015, the content of which is incorporated herein by reference.

### BACKGROUND ART

In a rotary machine such as a centrifugal compressor, there is a rotary shaft of which an end protrudes to an outside of a casing to input or output a rotational force of a rotary shaft rotatably provided in the casing. In this case, it is necessary to prevent leakage of a working fluid in the casing to the outside of the casing and infiltration of foreign substances or the like into the casing from the outside thereof through a gap between the rotary shaft and a shaft insertion hole formed in the casing for the rotary shaft to pass through the casing. Therefore, a gas seal portion is provided between the rotary shaft and the casing.

The gas seal portion includes a rotary ring and a stationary ring. The rotary ring is provided integrally with the rotary shaft on an outer circumferential portion of the rotary shaft. The stationary ring is fixed to the casing and is provided to face the rotary ring in an axial direction of the rotary shaft. The stationary ring is pressed toward the rotary ring by a coil spring or the like. Therefore, in a state in which the rotary machine is stopped, the stationary ring and the rotary ring abut on each other. In addition, a spiral groove is formed on a surface of the rotary ring facing the stationary ring. When the rotary machine is operated and the rotary shaft rotates, a seal gas is introduced between the rotary ring and the stationary ring by the spiral groove. Due to a pressure of the gas, the stationary ring is pressed in the axial direction of the rotary shaft against a biasing force of the coil spring. As a result, a minute gap is formed between the rotary ring and the stationary ring. The seal gas is caused to flow from an inside of the rotary machine toward an outside thereof through the gap, and thus sealing between the rotary shaft and the casing is achieved. In this case, the pressure of the seal gas is higher than the pressure inside and outside the rotary machine.

In such a gas seal portion, the seal gas flowing from the inside of the rotary machine to the outside thereof via the gap between the rotary ring and the stationary ring is discharged to an outside through a vent (chimney) connected to the casing.

A gas or the like discharged from equipment other than the rotary machine may be delivered into the vent and may be discharged to the outside together with the seal gas. Further, depending on a type of the gas, the gas may be burned near an outlet of the vent. When the gas or the like is delivered into the vent from the equipment other than the rotary machine or the gas is burned, a pressure in the vent is increased. When the pressure in the vent becomes higher than that of the inside of the machine, the seal gas flows backward in the gap between the rotary ring and the stationary ring. Then, the rotary ring and the stationary ring may collide with each other, and thus the gas seal portion may be damaged.

Patent Document 1 discloses a constitution which includes a flow rate switch for detecting a flow rate of a gas leaking from the gas seal portion to the vent. Accordingly, when a working gas leaks due to breakage of the gas seal portion and the flow rate of the gas at the vent is increased, an abnormality is detected.

The constitution disclosed in Patent Document 1 is for detecting the breakage of the gas seal portion due to a backflow or the like of the seal gas from the vent to the gas seal portion as the abnormality. That is, it is not for preventing the breakage of the gas seal portion by suppressing a backflow of the seal gas.

Therefore, the pressure of the seal gas is usually controlled so that the pressure of the seal gas in the gas seal portion is reliably maintained at a higher level than the pressure of the vent inside and outside the rotary machine.

### CITATION LIST

### Patent Literature

Patent Document 1

Japanese Patent No. 3979092

However, in a pipe constituting a supply line for feeding the seal gas to the gas seal portion, pressure loss occurs. Even if the seal gas is delivered from a supply source side of the seal gas with a pressure higher than the pressure inside the vent and the pressure inside the rotary machine, the pressure of the seal gas is lowered by the pressure loss in the supply line when the seal gas reaches the gas seal portion.

Also, the pressure of the gas in the vent which is discharged through the vent is varied by combustion of the gas delivered from the equipment other than the rotary machine or the gas in the vent. Even if the variation is taken into consideration, it is necessary to keep the pressure of the seal gas in the gas seal portion high.

Therefore, the pipe is formed to be as thick as possible so that the pressure loss is suppressed and the pressure of the seal gas is kept high. However, the cost is increased as the pipe becomes thicker.

Also, a magnitude of the pressure loss generated can vary variously depending on conditions such as a pipe diameter, a piping layout, a pressure of a working fluid in a compressor and so on. Therefore, actually, whenever the rotary machine is installed, it is necessary to set an optimum pipe diameter according to various conditions at an installation position thereof, which increases effort and cost.

### SUMMARY OF INVENTION

The present invention provides a rotary machine system which is capable of limiting the piping cost, the design cost and the design effort for supplying a seal gas while suppressing backflow of the seal gas.

A rotary machine system of a first aspect of the present invention may include a rotary machine having a gas seal portion, a gas seal device connected to the rotary machine and configured to supply a seal gas to the gas seal portion, and a pressure sensor configured to detect the pressure of the seal gas, wherein the rotary machine includes a casing through which a working fluid flows, a rotary shaft configured to pass through an inside and an outside of the casing and provided to be rotatable, and the gas seal portion provided between the casing and the rotary shaft and configured to seal the working fluid by the seal gas having a pressure higher than that of the working fluid in the casing, the gas seal device includes a pressure regulating valve configured to adjust the pressure of the seal gas supplied to the gas seal portion, and a control part (controller) configured to control the pressure regulating valve, the pressure sensor is provided closer to the gas seal portion side than the gas seal device, and the control part controls the pressure regulating valve according to the pressure of the seal gas detected by the pressure sensor.

According to one or more embodiments as described above, since the pressure sensor is provided closer to the gas seal portion side of the rotary machine than the gas seal device, the pressure can be detected while pressure loss occurring before the seal gas reaches the gas seal portion is suppressed compared with the case in which the pressure sensor is provided at a supply source side of the seal gas in the gas seal device. Therefore, in order to limit the pressure loss, it is not necessary to increase a pipe diameter for supplying the seal gas, and thus the pipe diameter can be suppressed, and the pressure sensor can detect the pressure with a small difference from the pressure of the seal gas in the gas seal portion.

Further, since it is not necessary to consider the pressure loss occurring before the seal gas reaches the gas seal portion, it is not necessary to consider conditions such as a layout of the pipe for supplying the seal gas or the pressure of the working fluid in the rotary machine either at the time of designing. Additionally, even when the gas seal device has a plurality of pipes, pipe diameters thereof can be unified. Further, it is not necessary to design while taking the pressure loss at connection portions of the plurality of pipes into consideration.

Further, in a rotary machine system of a second aspect of the present invention, the pressure sensor of the first aspect may be provided in a connection pipe portion which connects the gas seal portion and the gas seal device.

According to one or more embodiments as described above, the pressure sensor can be installed at a position of the gas seal device close to the gas seal portion by providing the pressure sensor at the connection pipe portion which connects the gas seal portion and the gas seal device. Furthermore, when the pressure sensor is provided in the pipe connection portion, it is not necessary to provide the opening or the like for installing the pressure sensor in the casing of the rotary machine. Therefore, the constitution of the present invention can be applied to an existing rotary machine.

Further, in a rotary machine system of a third aspect of the present invention, the pressure sensor of the second aspect may be provided in the connection pipe portion within a range of ⅓ of an overall length of the connection pipe portion from the gas seal portion side.

According to one or more embodiments as described above, the difference between the pressure of the seal gas detect by the pressure sensor and the pressure of the seal gas in the gas seal portion can be reduced to be small by providing the pressure sensor as close as possible to the gas seal portion.

Further, in a rotary machine system of a fourth aspect of the present invention, the connection pipe portion of the second or third aspect may include a connection hole portion provided at a position of the casing which faces the gas seal portion, and one or more connecting pipes configured to connect the connection hole portion and the gas seal device, and the pressure sensor may be provided in the connection hole portion.

According to one or more embodiments as described above, the pressure sensor can be provided close to the inside of the gas seal portion by providing the pressure sensor at the connection hole portion provided in the casing for connecting the connecting pipes. Therefore, the difference between the pressure of the seal gas detected by the pressure sensor and the pressure of the seal gas in the gas seal portion can be reduced to be small.

Further, in a rotary machine system of a fifth aspect of the present invention, the pressure sensor of the first aspect may be provided in an opening of the casing which faces the gas seal portion.

With such a constitution according to one or more embodiments, the pressure sensor is installed at a position which directly faces the gas seal portion. Therefore, the pressure sensor can directly detect the pressure of the seal gas in the gas seal portion without being affected by the pressure loss generated in the pipe through which the seal gas is delivered into the gas seal portion.

Further, a rotary machine system of a sixth aspect of the present invention may further include an internal pressure sensor configured to detect the internal pressure of the machine closer to an inside of the rotary machine than the gas seal portion of one of the first to fifth aspects, and the control part may control the pressure regulating valve so that the pressure of the seal gas detect by the pressure sensor is higher than the internal pressure of the machine which is detect by internal pressure sensor.

With such a constitution according to one or more embodiments, the pressure of the seal gas in the gas seal portion can be maintained higher than the internal pressure of the machine, and the leakage of the seal gas to the inside of the machine can be suppressed.

Further, a rotary machine system of a seventh aspect of the present invention may further include a vent portion configured to discharge the seal gas discharged from the gas seal portion of any one of the first to sixth aspects to the outside, and a vent pressure sensor configured to detect the pressure in the vent portion, and the control part may control the pressure regulating valve so that the pressure of the seal gas detected by the pressure sensor is higher than the pressure in the vent portion detected by the vent pressure sensor.

With such a constitution according to one or more embodiments, the pressure of the seal gas in the gas seal portion can be maintained higher than the pressure in the vent, and the leakage of the seal gas to the vent can be reliably suppressed regardless of a variation of the pressure in the vent.

According to one or more embodiments of the above-described rotary machine system, the pressure of the seal gas in the gas seal portion can be detected with high accuracy by suppressing a difference between the pressure of the seal gas detected by the pressure sensor and the pressure of the seal gas in the gas seal portion. As a result, a pipe diameter through which the seal gas is supplied to the gas seal portion can be minimized while backflow of the seal gas is suppressed, and thus the piping cost, the design cost and the design effort of the pipe for supplying the seal gas can be limited.

### BRIEF DESCRIPTION OF DRAWINGS

FIG. 1 is a view showing a schematic constitution of a rotary machine system with a compressor as an example of a rotary machine in an embodiment.

FIG. 2 is a view showing a constitution of a gas seal portion provided at the compressor in a first embodiment.

FIG. 3 is a view showing a constitution of a gas seal portion provided at the compressor in a second embodiment.

FIG. 4 is a view showing a constitution of a gas seal portion provided at the compressor in a third embodiment.

### DESCRIPTION OF EMBODIMENTS

Hereinafter, embodiments for implementing a rotary machine system according to the present invention will be described with reference to the accompanying drawings. However, the present invention is not limited to only these embodiments.

### First Embodiment

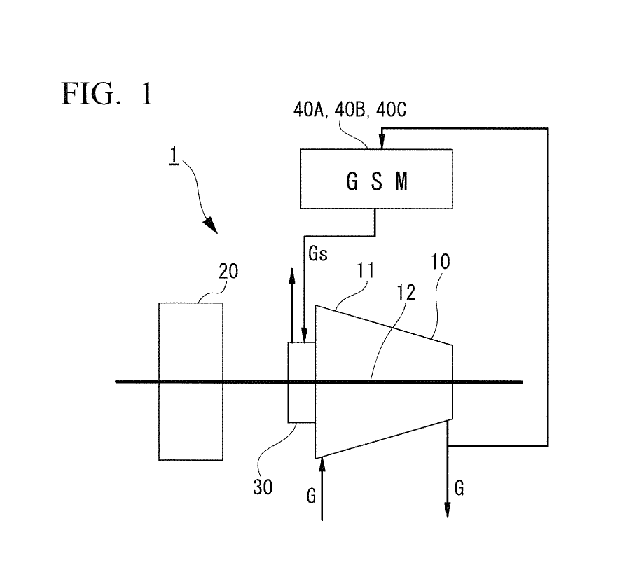

FIG. 1 is a view showing a schematic constitution of a rotary machine system with a compressor as an example of a rotary machine in an embodiment.

As shown in FIG. 1, a rotary machine system 1 includes a compressor (rotary machine) 10, a turbine 20 as a drive source for driving the compressor 10, and a gas seal module (GSM: gas seal device) 40A for supplying a seal gas Gs to the compressor 10.

The compressor 10 is, for example, a centrifugal compressor, and includes a rotary shaft 12 and a compression part (not shown) such as an impeller, which rotates integrally with the rotary shaft 12 and compresses a gas G serving as a working fluid, in a casing 11. A gas seal portion 30 is provided in a portion on a suction side of the compressor 10 in which the rotary shaft 12 passes through an end of the casing 11 and protrudes outward.

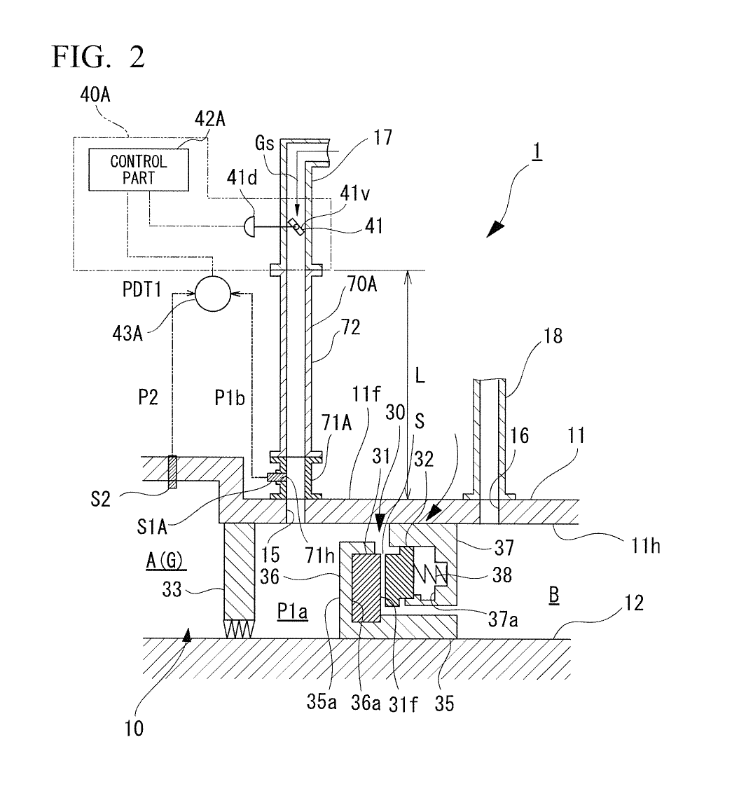

FIG. 2 is a view showing a constitution of the gas seal portion provided at the compressor 10 in a first embodiment.

As shown in FIG. 2, the gas seal portion 30 includes a rotary ring 31, a stationary ring 32 and a labyrinth seal 33 on an inside of the machine.

The rotary ring 31 is provided integrally with the rotary shaft 12 on an outer circumferential portion of the rotary shaft 12. A cylindrical shaft sleeve 35 is fixed to the outer circumferential portion of the rotary shaft 12. A holder portion 36 extending toward an outer circumferential side is provided at an end 35a of the shaft sleeve 35 on the inside A (left side in FIG. 2) of the machine. In the holder portion 36, a holding recess 36a for holding the rotary ring 31 is provided on an outside B (right side in FIG. 2) of the machine.

The rotary ring 31 is formed in an annular shape and fitted and held in the holding recess 36a. In the rotary ring 31, a spiral groove (not shown) is provided on a surface 31f facing the stationary ring 32.

The stationary ring 32 is provided in the casing 11. A shaft insertion hole 11h through which an end of the rotary shaft 12 passes through an inside and an outside of the casing 11 is provided in the casing 11.

An annular retainer 37 is provided on an inner circumferential surface of the shaft insertion hole 11h. A holding recess 37a for holding the stationary ring 32 is provided on the inside A of the machine in the retainer 37. In the holding recess 37a, the stationary ring 32 is provided to be slide-able in an axial direction of the rotary shaft 12. A coil spring 38 for biasing the stationary ring 32 toward the inside A of the machine is provided in the holding recess 37a between the stationary ring 32 and the retainer 37.

The rotary ring 31 and the stationary ring 32 are provided to face each other in the axial direction of the rotary shaft 12. The stationary ring 32 is pressed toward the rotary ring 31 by the coil spring 38.

A seal gas supply port 15 which opens on the inner circumferential surface of the shaft insertion hole 11h is provided in the casing 11. The seal gas supply port 15 is provided between the rotary ring 31 and the labyrinth seal 33 on the inside of the machine in the axial direction of the rotary shaft 12.

A seal gas supply path 17 is connected to the seal gas supply port 15. The seal gas supply path 17 supplies a part of the gas G compressed by the compressor 10 as the seal gas Gs from a discharge side of the compressor 10 to the seal gas supply port 15.

A vent discharge port 16 which opens on the inner circumferential surface of the shaft insertion hole 11h is provided in the casing 11. The vent discharge port 16 is provided on the outside B of the machine in the casing 11 from the rotary ring 31 in the axial direction of the rotary shaft 12.

A vent (chimney; vent portion) 18 is connected to the vent discharge port 16. The vent 18 discharges the seal gas Gs flowing out from the gas seal portion 30 to an outside via the vent 18. In addition to the compressor 10, other devices are connected to the vent 18.

In such a gas seal portion 30, the stationary ring 32 and the rotary ring 31 abut on each other in a state in which the compressor 10 is stopped.

In a state in which the compressor 10 is operated, the seal gas Gs is introduced into a space between the shaft insertion hole 11h of the casing 11 and the rotary shaft 12 through the seal gas supply path 17 and the seal gas supply port 15. When the compressor 10 is operated and the rotary shaft 12 rotates, the seal gas Gs is introduced between the rotary ring 31 and the stationary ring 32 from an outer circumference side of the rotary ring 31 by the spiral groove provided on the surface 31f of the rotary ring 31. When the stationary ring 32 is pressed toward the outside B of the machine in the axial direction of the rotary shaft 12 against a biasing force of the coil spring 38 by a pressure of the seal gas Gs, a minute seal gap S is formed between the rotary ring 31 and the stationary ring 32. The seal gas Gs passes through the seal gap S and flows toward the outside B of the machine. In this manner, the seal gas Gs is caused to flow from the inside A of the machine toward the outside B thereof, and thus sealing between the rotary shaft 12 and the casing 11 is achieved.

Further, the seal gas Gs flows from the rotary ring 31 and stationary ring 32 side to the inside A of the machine through a space between the labyrinth seal 33 on the inside of the machine and the rotary shaft 12. As a result, foreign substances or the like are prevented from being introduced into the seal gap S between the rotary ring 31 and the stationary ring 32 from the inside A of the machine.

To prevent the seal gas Gs delivered into the casing 11 through the seal gas supply path 17 from flowing backward in the gas seal portion 30, the gas seal module 40A adjusts the pressure of the seal gas Gs to be higher than that of the inside A of the machine.

The gas seal module 40A includes a pressure regulating valve 41 and a control part 42A which controls an opening degree of the pressure regulating valve 41.

The pressure regulating valve 41 is provided in the seal gas supply path 17. The pressure regulating valve 41 includes a valve body 41v and a valve driving part 41d. The valve body 41v is provided in the seal gas supply path 17 and is driven by the valve driving part 41d to increase or decrease a flow path area of the seal gas supply path 17. The pressure regulating valve 41 adjusts a supply pressure P1b of the seal gas Gs supplied into the casing 11 through the seal gas supply path 17 by varying the opening degree of the valve body 41v by the valve driving part 41d. An operation of the valve driving part 41d is controlled by the control part 42A.

The control part 42A controls the valve driving part 41d of the pressure regulating valve 41 on the basis of the supply pressure P1b of the seal gas Gs and an internal pressure P2 of the machine.

The supply pressure P1b of the seal gas Gs is detected by a seal gas pressure sensor S1A provided closer to the compressor 10 side than the pressure regulating valve 41 of the gas seal module 40A. The seal gas pressure sensor S1A may be provided at a position as close as possible to the gas seal portion 30 so that the supply pressure P1b of the seal gas Gs can be detected while an influence of pressure loss in the seal gas supply path 17 is minimized as much as possible. Specifically, the seal gas pressure sensor S1A is provided closer to the gas seal portion 30 side than the pressure regulating valve 41 in the seal gas supply path 17.

Here, in the seal gas supply path 17, a port connection hole (connection hole portion) 71A is provided on an outer circumferential surface of the casing 11 and communicates with the seal gas supply port 15, and one or more connecting pipes 72 (the example of FIG. 2 shows one, and they are connected to each other if there are a plurality) are provided at a connection pipe portion 70A which connects the gas seal module 40A and the casing 11 of the compressor 10.

The connecting pipe 72 has a straight tubular shape in FIG. 2 but is actually appropriately bent to avoid interference with various devices because the various devices are arranged around the compressor 10. Also, a length of the connecting pipe 72 is detected according to an installation interval between the compressor 10 and the gas seal module 40 A and may have a range of, for example, 20 to 30 m.

In the embodiment, the seal gas pressure sensor S1A may be provided at a position of L/3 or less from an outer surface 11f of the casing 11 with respect to a pipe length L of the connection pipe portion 70A from the pressure regulating valve 41 of the gas seal module 40A to the outer surface 11f of the casing 11 in which the port connection hole 71A is provided. That is, the seal gas pressure sensor S1A is provided in a through-hole 71h provided in the port connection hole 71A which is closest to the outer circumferential surface of the casing 11 in the connection pipe portion 70A.

The internal pressure P2 of the machine is detected by an internal pressure sensor S2 which is provided closer to the inside A of the machine in the casing 11 than the gas seal portion 30 and the labyrinth seal 33 on the inside of the machine.

The seal gas pressure sensor S1A and the internal pressure sensor S2 are connected to a differential pressure gauge 43A. The differential pressure gauge 43A detects a differential pressure PDT1(=P1b−P2) in the machine between the supply pressure P1b of the seal gas Gs supplied into the casing 11 through the connection pipe portion 70A with respect to the gas seal portion 30 and the internal pressure P2 of the machine of the casing 11. A signal indicating the detected differential pressure PDT1 in the machine is transmitted to the control part 42A.

During an operation of the compressor 10, the control part 42A obtains the differential pressure PDT1 in the machine which is detected by the differential pressure gauge 43A at predetermined time intervals.

When the detected differential pressure PDT1 in the machine is equal to or more than a predetermined lower limit threshold value, or less than a predetermined upper limit threshold value, the supply pressure P1b of the seal gas Gs is sufficiently higher than the internal pressure P2 of the machine, and thus the operation is continued as it is without changing the opening degree of the pressure regulating valve 41.

Further, when the detected differential pressure PDT1 in the machine is less than the predetermined lower limit threshold value, the supply pressure P1b of the seal gas Gs is not sufficiently higher than the internal pressure P2 of the machine, and thus the opening degree of the pressure regulating valve 41 is increased. Then, the supply pressure P1b of the seal gas Gs supplied into the casing 11 through the connection pipe portion 70A is increased. As a result, the differential pressure PDT1 in the machine between the supply pressure P1b of the seal gas Gs and the internal pressure P2 of the machine is increased.

Further, here, when the differential pressure PDT1 in the machine is less than the predetermined lower limit threshold value, the opening degree of the pressure regulating valve 41 is increased, but an amount of change in the opening degree may be, for example, a preset amount of change in the opening degree according to a magnitude of the differential pressure PDT1 in the machine, or the opening degree of the pressure regulating valve 41 may be increased by a predetermined amount in every operation process.

Further, when the detected differential pressure PDT1 in the machine exceeds the predetermined upper limit threshold value, the supply pressure P1b of the seal gas Gs is excessively higher than the internal pressure P2 of the machine, and a flow rate of the seal gas flowing into the inside A of the machine is increased, and thus the flow rate of the gas G which is compressed by the compressor 10 is reduced. Therefore, the control part 42A reduces the opening degree of the pressure regulating valve 41.

As described above, by adjusting the opening degree of the pressure regulating valve 41 by the control part 42A on the basis of the supply pressure P1b of the seal gas Gs which is detected by the seal gas pressure sensor S1A and the internal pressure P2 of the machine which is detected by the internal pressure sensor S2, a pressure P1a of the seal gas Gs in the gas seal portion 30 inside the casing 11 can always be kept higher than the internal pressure P2 of the machine.

Accordingly, a backflow of the seal gas Gs from the gas seal portion 30 toward the inside A of the machine of the compressor 10 can be prevented.

According to the rotary machine system 1 as described above, the pressure sensor S1A is provided closer to the connection pipe portion 70A on the gas seal portion 30 side than the gas seal module 40A. Further, the control part 42A controls the pressure regulating valve 41 according to the supply pressure P1b of the seal gas Gs detected by the pressure sensor S1A.

As described above, since the pressure sensor S1A is provided closer to the gas seal portion 30 side than the gas seal module 40A, the pressure can be detected while the pressure loss occurring before the seal gas Gs reaches the gas seal portion 30 is suppressed as compared with the case in which the pressure sensor S1A is provided on a supply source side of the seal gas Gs in the gas seal module 40A. Accordingly, it is not necessary to increase a pipe diameter of the seal gas supply path 17 for supplying the seal gas Gs in order to suppress the pressure loss, and thus it is possible to minimize the pipe diameter.

Further, since it is not necessary to consider the pressure loss occurring before the seal gas Gs reaches the gas seal portion 30, it is not necessary to consider conditions such as a layout of the seal gas supply path 17 for supplying the seal gas Gs and the pressure of the gas G in the compressor 10 either at the time of designing. Additionally, even when the connection pipe portion 70A has a plurality of pipes, pipe diameters thereof can be unified. Further, it is not necessary to design in consideration of the pressure loss at connection portions among the plurality of pipes.

Therefore, the piping cost, the design cost and the design effort of the seal gas supply path 17 can be limited while backflow of the seal gas Gs is reliably suppressed.

Further, when the pressure sensor S1A is provided in the connection pipe portion 70A, it is not necessary to provide an opening or the like for installing the pressure sensor S1A in the casing 11 of the compressor 10. Also, in one or more embodiments, the constitution of the present invention can be applied to an existing compressor 10.

Further, the pressure sensor S1A is provided in the connection pipe portion 70A within a range of L/3 from the gas seal portion 30 side with respect to a total length L of the connection pipe portion 70A. As described above, a difference between the supply pressure P1b of the seal gas Gs detected by the pressure sensor S1A and the pressure P1a of the seal gas Gs in the gas seal portion 30 can be suppressed to be small by providing the pressure sensor S1A as close as possible to the gas seal portion 30.

Further, the pressure sensor S1A can be provided close to an inside of the gas seal portion 30 by providing the pressure sensor S1A in the port connection hole 71A provided in the casing 11. Therefore, the difference between the supply pressure P1b of the seal gas Gs detected by the pressure sensor S1A and the pressure P1a of the seal gas Gs in the gas seal portion 30 can be suppressed to be small.

Further, the rotary machine system 1 further includes the internal pressure sensor S2 for detecting the internal pressure of the machine closer to the inside of the compressor 10 than the gas seal portion 30, and the control part 42A controls the pressure regulating valve 41 so that the supply pressure P1b of the seal gas Gs detected by the pressure sensor S1A is higher than the internal pressure P2 of the machine detected by the internal pressure sensor S2. By constituting the rotary machine system 1 as described above, the pressure P1a of the seal gas Gs in the gas seal portion 30 can be maintained higher than the internal pressure P2 of the machine, and leakage of the gas G from the compressor 10 can be suppressed.

### Second Embodiment

Next, a second embodiment of the rotary machine system according to the present invention will be described. In the second embodiment to be described, the same reference numerals are provided for the elements common to those of the first embodiment, and a description thereof will be omitted.

As shown in FIG. 1, the rotary machine system 1 of the embodiment includes a compressor 10, a turbine 20 and a gas seal module (gas seal device) 40B.

The compressor 10 includes a rotary shaft 12 and a compression part (not shown) in a casing 11. In a suction side of the compressor 10, a gas seal portion 30 is provided in a portion in which the rotary shaft 12 passes through an end of the casing 11 and protrudes outward.

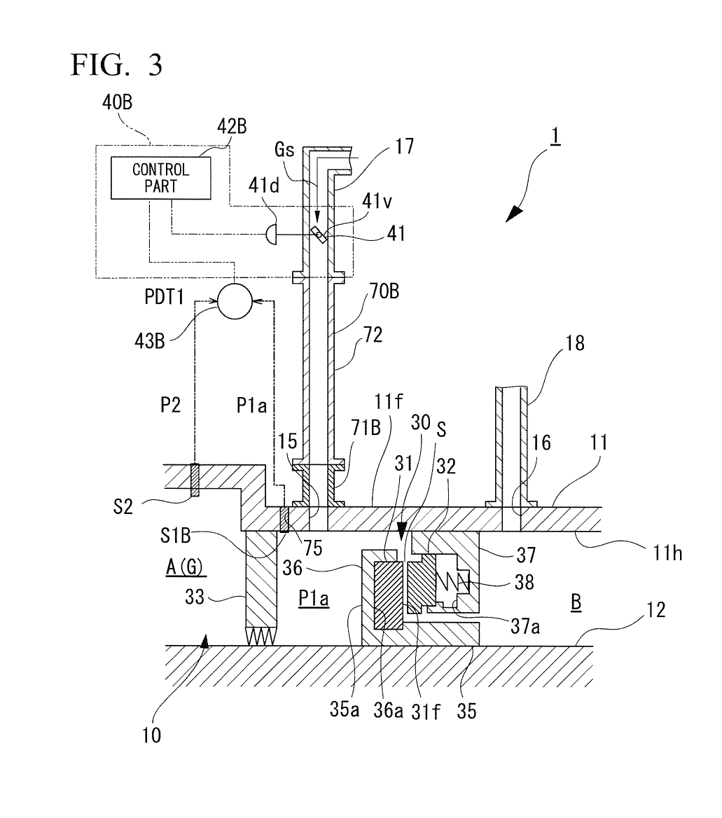

FIG. 3 is a view showing a constitution of the gas seal portion provided at the compressor 10 in the second embodiment.

As shown in FIG. 3, the gas seal portion 30 includes a rotary ring 31, a stationary ring 32 and a labyrinth seal 33 on an inside of the machine.

A seal gas supply port 15 which opens on an inner circumferential surface of a shaft insertion hole 11h is provided in the casing 11. A seal gas supply path 17 is connected to the seal gas supply port 15. In the seal gas supply path 17, a cylindrical port connection hole 71B and a connecting pipe 72 are provided in a connection pipe portion 70B which connects the gas seal module 40B and the casing 11 of the compressor 10.

Further, a vent discharge port 16 which opens on the inner circumferential surface of the shaft insertion hole 11h is provided in the casing 11. A vent 18 is connected to the vent discharge port 16.

To prevent the seal gas Gs delivered into the casing 11 through the seal gas supply path 17 from flowing backward in the gas seal portion 30, the gas seal module 40B adjusts a pressure thereof to be higher than that in an inside A of the machine.

The gas seal module 40B includes a pressure regulating valve 41 which is provided in the seal gas supply path 17 and a control part 42B which controls an opening degree of the pressure regulating valve 41.

The control part 42B controls a valve driving part 41d of the pressure regulating valve 41 on the basis of a pressure P1a of the seal gas Gs in the gas seal portion 30 and an internal pressure P2 of the machine.

The pressure P1a of the seal gas Gs is detected by a seal gas pressure sensor S1B which is provided in the seal gas supply path 17 to be closer to the compressor 10 side than the pressure regulating valve 41 of the gas seal module 40B. In the embodiment, the seal gas pressure sensor S1B is provided in an opening 75 which is provided at a position facing the gas seal portion 30 in the casing 11.

The internal pressure P2 of the machine is detected by an internal pressure sensor S2 which is provided closer to the inside A of the machine in the casing 11 than the gas seal portion 30 and the labyrinth seal 33 on the inside of the machine.

The seal gas pressure sensor S1B and the internal pressure sensor S2 are connected to a differential pressure gauge 43B. The differential pressure gauge 43B detects a differential pressure PDT1(=P1a−P2) in the machine between the pressure P1a of the seal gas Gs in the gas seal portion 30 inside the casing 11 and the internal pressure P2 of the machine of the casing 11. A signal indicating the detected differential pressure PDT1 in the machine is transmitted to the control part 42B.

During an operation of the compressor 10, the control part 42B obtains the differential pressure PDT1 in the machine which is detected by the differential pressure gauge 43B at predetermined time intervals.

When the detected differential pressure PDT1 in the machine is equal to or more than a predetermined lower limit threshold value, or less than a predetermined upper limit threshold value and the pressure P1b of the seal gas Gs in the gas seal portion 30 is sufficiently higher than the internal pressure P2 of the machine, the operation is continued as it is without changing the opening degree of the pressure regulating valve 41.

When the detected differential pressure PDT1 in the machine is less than the predetermined lower limit threshold value, the pressure P1a of the seal gas Gs is not sufficiently higher than the internal pressure P2 of the machine, and thus the opening degree of the pressure regulating valve 41 is increased. Then, the flow rate of the seal gas Gs supplied into the casing 11 through the seal gas supply path 17 is increased, and thus the pressure P1a is also increased. As a result, the differential pressure PDT1 in the machine between the pressure P1a of the seal gas Gs in the gas seal portion 30 and the internal pressure P2 of the machine is increased.

Here, when the differential pressure PDT1 in the machine is less than the predetermined lower limit threshold value, the opening degree of the pressure regulating valve 41 is increased. The amount of change in the opening degree thereof may be, for example, a preset amount of change in the opening degree according to a magnitude of the differential pressure PDT1 in the machine. Also, the opening degree of the pressure regulating valve 41 may be increased by a predetermined amount in every operation process.

Further, in the control part 42B, when the detected differential pressure PDT1 in the machine exceeds the predetermined upper limit threshold value, the pressure P1a of the seal gas Gs in the gas seal portion 30 is excessively higher than the internal pressure P2 of the machine. Additionally, the flow rate of the seal gas flowing into the inside A of the machine is increased, and thus the flow rate of the gas G which is compressed by the compressor 10 is reduced. Therefore, the control part 42B reduces the opening degree of the pressure regulating valve 41.

As described above, by adjusting the opening degree of the pressure regulating valve 41 by the control part 42B on the basis of the pressure P1a of the seal gas Gs in the gas seal portion 30 inside the casing 11 which is detected by the seal gas pressure sensor S1B and the internal pressure P2 of the machine which is detected by the internal pressure sensor S2, the pressure P1a of the seal gas Gs in the gas seal portion 30 can always be kept higher than the internal pressure P2 of the machine. Accordingly, a backflow of the seal gas Gs from the gas seal portion 30 toward the inside A of the machine of the compressor 10 can be prevented even when the pressure in the vent 18 is sharply increased.

According to the rotary machine system 1 of the embodiment as described above, as in the first embodiment, the pressure loss occurring before the seal gas Gs reaches the gas seal portion 30 can be suppressed by providing the pressure sensor S1B closer to the gas seal portion 30 side than the gas seal module 40B. Therefore, a pipe diameter of the seal gas supply path 17 through which the seal gas Gs is supplied to the gas seal portion 30 can be minimized while the backflow of the seal gas Gs is suppressed, and thus a piping cost, the design cost and the design effort of the seal gas supply path 17 can be limited.

Particularly, in the embodiment, the pressure sensor S1B is provided in the opening 75 formed in the casing 11 to face the gas seal portion 30.

With such a constitution, the pressure sensor S1B is provided at a position which directly faces the gas seal portion 30. Therefore, the pressure sensor S1B can detect the pressure of the seal gas Gs in the gas seal portion 30 without being affected by the pressure loss generated in the pipe while the seal gas Gs is delivered into the gas seal portion 30.

### Third Embodiment

Next, a third embodiment of the rotary machine system according to the present invention will be described. In the third embodiment to be described, the same reference numerals are provided to the elements common to those of the first embodiment and the second embodiment, and the description thereof will be omitted.

As shown in FIG. 1, the rotary machine system 1 of the embodiment includes a compressor 10, a turbine 20 which is a drive source for driving the compressor 10 and a gas seal module (gas seal device) 40C which supplies the seal gas Gs to the compressor 10.

The compressor 10 includes a rotary shaft 12 and a compression part (not shown) in a casing 11. In a suction side of the compressor 10, a gas seal portion 30 is provided in a portion in which the rotary shaft 12 passes through an end of the casing 11 and protrudes outward.

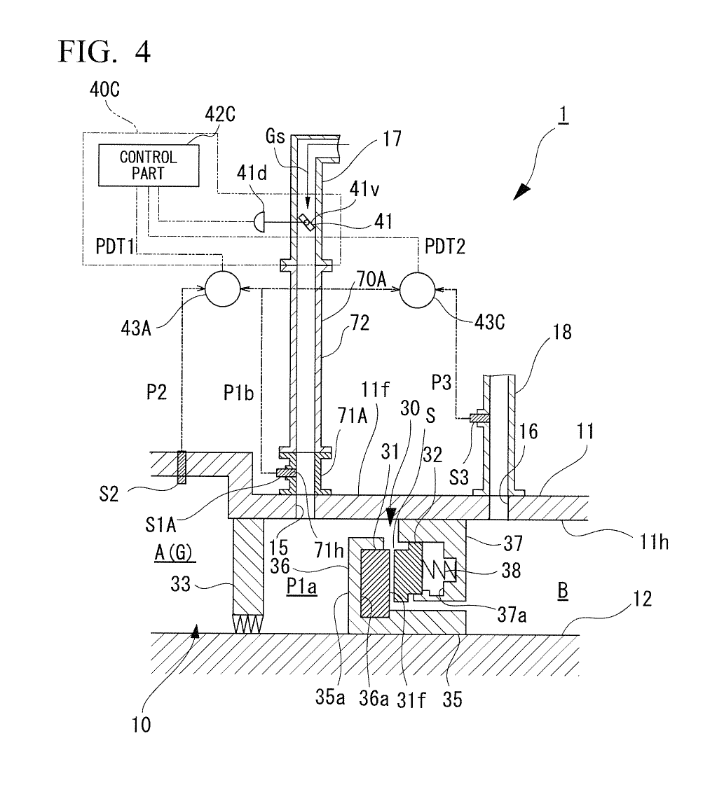

FIG. 4 is a view showing a constitution of the gas seal portion provided at the compressor 10 in a third embodiment.

As shown in FIG. 4, the gas seal portion 30 includes a rotary ring 31, a stationary ring 32 and a labyrinth seal 33 on an inside of the machine.

A seal gas supply port 15 which opens on an inner circumferential surface of a shaft insertion hole 11h is provided in the casing 11. A seal gas supply path 17 is connected to the seal gas supply port 15.

A vent discharge port 16 which opens on the inner circumferential surface of the shaft insertion hole 11h is provided in the casing 11. A vent 18 is connected to the vent discharge port 16.

To prevent the seal gas Gs delivered into the casing 11 through the seal gas supply path 17 from flowing backward in the gas seal portion 30, the gas seal module 40C adjusts a pressure thereof to be higher than that in an inside A of the machine and the vent 18.

The gas seal module 40C includes a pressure regulating valve 41 and a control part 42C which controls an opening degree of the pressure regulating valve 41.

The pressure regulating valve 41 is provided in the seal gas supply path 17. The pressure regulating valve 41 adjusts a supply pressure P1b of the seal gas Gs supplied into the casing 11 through the seal gas supply path 17 by varying the opening degree of a valve body 41v by a valve driving part 41d.

The control part 42C controls the valve driving part 41d of the pressure regulating valve 41 on the basis of the supply pressure P1b of the seal gas Gs, an internal pressure P2 of the machine and a vent pressure P3 in the vent 18.

The supply pressure P1b of the seal gas Gs is detected by a seal gas pressure sensor S1A provided closer to the compressor 10 side than the pressure regulating valve 41 of the gas seal module 40C. In the embodiment, the seal gas pressure sensor S1A is provided in a through-hole 71h formed in a port connection hole 71A which is closest to an outer circumferential surface of the casing 11 in a connection pipe portion 70A that connects the gas seal module 40C and the casing 11 of the compressor 10.

The internal pressure P2 of the machine is detected by an internal pressure sensor S2 provided closer to an inside A of the machine of the casing 11 than the gas seal portion 30 and the labyrinth seal 33 on the inside of the machine.

The vent pressure P3 is determined by a vent pressure sensor S3 provided in the vent 18.

The seal gas pressure sensor S1A and the internal pressure sensor S2 are connected to a differential pressure gauge 43A. The differential pressure gauge 43A detects a differential pressure PDT1(=P1b−P2) in the machine between the internal pressure P2 of the machine of the casing 11 and the supply pressure P1b of the seal gas Gs supplied into the casing 11 through the seal gas supply path 17 in the gas seal portion 30. A signal indicating the detected differential pressure PDT1 in the machine is transmitted to the control part 42C.

The seal gas pressure sensor S1A and the vent pressure sensor S3 are connected to a differential pressure gauge 43C. The differential pressure gauge 43C detects a vent differential pressure PDT2(=P1b−P3) between the supply pressure P1b of the seal gas Gs supplied into the casing 11 through the connection pipe portion 70A and the pressure P3 in the vent 18. A signal indicating the detected vent differential pressure PDT2 is transmitted to the control part 42C.

During an operation of the compressor 10, the control part 42C obtains the differential pressure PDT1 in the machine and the vent differential pressure PDT2 which are detected by the differential pressure gauges 43A and the 43C at predetermined time intervals.

When the detected differential pressure PDT1 in the machine is equal to or more than a predetermined lower limit threshold value, or less than a predetermined upper limit threshold value, the supply pressure P1b of the seal gas Gs is sufficiently higher than the internal pressure P2 of the machine, and thus the operation is continued as it is without changing the opening degree of the pressure regulating valve 41.

Further, when the detected differential pressure PDT1 in the machine is less than the predetermined lower limit threshold value, the supply pressure P1b of the seal gas Gs is not sufficiently higher than the internal pressure P2 of the machine, and thus the opening degree of the pressure regulating valve 41 is increased. Then, the supply pressure P1b of the seal gas Gs supplied into the casing 11 through the seal gas supply path 17 is increased. As a result, the differential pressure PDT1 in the machine between the supply pressure P1b of the seal gas Gs and the internal pressure P2 of the machine is increased.

Further, when the detected differential pressure PDT1 in the machine exceeds the predetermined upper limit threshold value, the supply pressure P1b of the seal gas Gs is excessively higher than the internal pressure P2 of the machine, and the flow rate of the seal gas flowing into the inside A of the machine is increased, and thus the flow rate of the gas G which is compressed by the compressor 10 is reduced. Therefore, the control part 42C reduces the opening degree of the pressure regulating valve 41.

Further, when the vent differential pressure PDT2 in the machine which is detected by the differential pressure gauge 43C is equal to or more than a predetermined threshold value, the supply pressure P1b of the seal gas Gs is sufficiently higher than the pressure P3 in the vent 18, and thus the operation is continued as it is without changing the opening degree of the pressure regulating valve 41.

For example, when a safety valve is released from equipment other than the compressor 10, the pressure P3 in the vent 18 may be increased. In this case, when the detected vent differential pressure PDT2 is less than the predetermined threshold value, the supply pressure P1b of the seal gas Gs is not sufficiently higher than the pressure P3 in the vent 18, and thus the opening degree of the pressure regulating valve 41 is increased.

Then, the supply pressure P1b of the seal gas Gs supplied into the casing 11 through the seal gas supply path 17 is increased. As a result, the vent differential pressure PDT2 between the supply pressure P1b of the seal gas Gs and the pressure P3 in the vent 18 is increased.

As described above, by adjusting the opening degree of the pressure regulating valve 41 by the control part 42C on the basis of the supply pressure P1b of the seal gas Gs which is detected by the seal gas pressure sensor S1A, the internal pressure P2 of the machine which is detected by the internal pressure sensor S2, and the vent pressure P3 which is detected by the vent pressure sensor S3, the pressure P1a of the seal gas Gs in the gas seal portion 30 inside the casing 11 can always be kept higher than the internal pressure P2 of the machine and the vent pressure P3. Accordingly, backflow of the seal gas Gs from the gas seal portion 30 toward the inside A of the machine of the compressor 10 can be prevented even when the pressure in the vent 18 is sharply increased.

According to the rotary machine system 1 as described above, like the first embodiment, the pressure loss occurring until the seal gas Gs reaches the gas seal portion 30, can be suppressed by providing the pressure sensor S1A closer to the gas seal portion 30 side than the gas seal module 40B. Therefore, a pipe diameter of the seal gas supply path 17 through which the seal gas Gs is supplied to the gas seal portion 30 can be minimized while the backflow of the seal gas Gs is suppressed, and thus the piping cost, the design cost and the designing effort of the seal gas supply path 17 can be limited.

Further, the above-described rotary machine system 1 further includes the vent pressure sensor S3 which detects the pressure in the vent 18, and the control part 42C controls the pressure regulating valve 41 so that the pressure of the seal gas Gs which is detected by the pressure sensor S1A is higher than the pressure in the vent 18 which is detected by the vent pressure sensor S3.

By constituting the rotary machine system 1 in this way, the pressure of the seal gas Gs in the gas seal portion 30 is reliably maintained higher than the pressure in the vent, and a leak of the seal gas Gs to the vent can be reliably suppressed regardless of variations of the pressure in the vent.

### Other Embodiments

In addition, the rotary machine system of the present invention is not limited to each of the above-described embodiments described with reference to the drawings, and various modifications are conceivable within the technical scope thereof.

For example, in the third embodiment, in addition to the constitution described in the first embodiment, the pressure P3 in the vent 18 is detected by the vent pressure sensor S3, and thus the pressure P1a of the seal gas Gs in the gas seal portion 30 is adjusted. Similarly, also in the constitution described in the second embodiment, the pressure P3 in the vent 18 may be detected by the vent pressure sensor S3, and the pressure P1a of the seal gas Gs in the gas seal portion 30 may be adjusted.

In the first and third embodiments, the seal gas pressure sensor S1A is provided in the port connection hole 71A which is the closest to the outer circumferential surface of the casing 11 in the connection pipe portion 70A for connecting the gas seal modules 40A and 40C and the casing 11 of the compressor 10, but the present invention is not limited thereto. The seal gas pressure sensor S1A may be provided in one of one or more connecting pipes 72 of the connection pipe portion 70A. Further, the seal gas pressure sensor S1A may be provided in the connecting pipe 72 which is the closest to the casing 11.

Further, the constitution of the gas seal portion 30 can be appropriately changed.

Further, the gas seal portion 30 has been provided on the suction side of the compressor 10, but the present invention is not limited thereto. The gas seal portion 30 may be provided at a discharge side of the compressor 10. In this case, the same operational effects as those in the above-described embodiments can be obtained.

In addition, for example, the overall constitution of the compressor 10 and the rotary machine system 1 may have any types.

According to the above-described rotary machine system, the pressure of the seal gas in the gas seal portion can be detected with high accuracy by suppressing the difference between the pressure of the seal gas detected by the pressure sensor and the pressure of the seal gas in the gas seal portion. As a result, the pipe diameter of the seal gas supply path through which the seal gas is supplied to the gas seal portion can be minimized while the backflow of the seal gas is suppressed, and thus the piping cost, the design cost and the designing effort of the pipe for supplying the seal gas can be limited.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Rotary machine system

10 Compressor (rotary machine)

11 Casing

11f Outer surface

11h Shaft insertion hole

12 Rotary shaft

15 Seal gas supply port

16 Vent discharge port

17 Seal gas supply path

18 Vent (vent portion)

20 Turbine

30 Gas seal portion

31 Rotary ring

31f Surface

32 Stationary ring

33 Labyrinth seal on inside of the machine

35 Shaft sleeve

35a End

36 Holder portion

36a Holding recess

37 Retainer

37a Holding recess

38 Coil spring

40A, 40B, 40C Gas seal module (gas seal device)

41 Pressure regulating valve

41d Valve driving part

41v Valve body

42A, 42B, 42C Control part

43A, 43B, 43C Differential pressure gauge

70A, 70B Connection pipe portion

71A Port connection hole (connection hole portion)

71B Port connection hole

71h Through-hole

72 Connecting pipe

75 Opening

A Inside of machine

B Outside of machine

G Gas (working fluid)

Gs Seal gas

P1a Pressure of seal gas in gas seal portion

P1b Supply pressure

P2 Internal pressure of machine

P3 Vent pressure

PDT1 Differential pressure in machine

PDT2 Vent differential pressure

S Seal gap

S1A, S1B Seal gas pressure sensor

S2 Internal pressure sensor

S3 Vent pressure sensor

1. A rotary machine system comprising:
a rotary machine comprising a gas seal portion;
a gas seal device connected to the rotary machine and that supplies a seal gas to the gas seal portion;
a pressure sensor that detects a pressure of the seal gas;
a vent portion that discharges the seal gas discharged from the gas seal portion to the outside; and
a vent pressure sensor that detects a pressure in the vent portion,
wherein the rotary machine comprises:
a casing through which a working fluid flows;
a rotatable rotary shaft that passes through an inside and an outside of the casing; and
the gas seal portion provided between the casing and the rotary shaft and that seals the working fluid by the seal gas having a pressure higher than a pressure of the working fluid in the casing,
the gas seal device comprises:
a pressure regulating valve that adjusts the pressure of the seal gas supplied to the gas seal portion; and
a control part that controls the pressure regulating valve,
the pressure sensor is provided closer to the gas seal portion side than the gas seal device,
pressure variations occurs in the vent portion, and
the control part controls the pressure regulating valve according to the pressure of the seal gas detected by the pressure sensor and controls the pressure regulating valve so that the pressure of the seal gas detected by the pressure sensor is higher than the pressure in the vent portion detected by the vent pressure sensor.

2. The rotary machine system according to claim 1, wherein the pressure sensor is provided in a connection pipe portion which connects the gas seal portion and the gas seal device.

3. The rotary machine system according to claim 2, wherein the pressure sensor is provided in the connection pipe portion within a range of ⅓ of an overall length of the connection pipe portion from the gas seal portion side.

4. The rotary machine system according to claim 2, wherein the connection pipe portion comprises:
a connection hole portion provided at a position of the casing which faces the gas seal portion, and
one or more connecting pipes that connects the connection hole portion and the gas seal device, and
the pressure sensor is provided in the connection hole portion.

5. The rotary machine system according to claim 1, wherein the pressure sensor is provided in an opening of the casing which faces the gas seal portion.

6. The rotary machine system according to claim 1, further comprising an internal pressure sensor that detects an internal pressure of the machine closer to an inside of the rotary machine than the gas seal portion,
wherein the control part controls the pressure regulating valve so that a pressure of the seal gas detected by the pressure sensor is higher than the internal pressure of the machine detected by the internal pressure sensor.

7. (canceled)
